(19) United States
(12) Patent Application Publication
(10) Pub. No.: US 2008/0243320 A1
(43) Pub. Date: Oct. 2, 2008

(54) Methods and systems for determining an integrity of a train

(75) Inventors: Tom Otsubo, Oak Grove, MO (US); Craig A. Stull, Kansas City, MO (US); William Crain Oberkramer, Blue Springs, MO (US)

Correspondence Address: JOHN S. BEULICK (12729);C/O ARMSTRONG TEASDALE LLP, ONE METROPOLITAN SQUARE, SUITE 2600, ST. LOUIS, MO, 63102-2740, US

(73) Assignee: General Electric Company

(21) Appl. No.: 11/731,387

(22) Filed: Mar. 30, 2007

(51) Int. Cl. G06F 19/00

(52) U.S. Cl. 701/19; 701/29

(57) ABSTRACT

A method for determining an integrity of a train is provided. The method includes coupling at least one head-of-train device to the train. The head-of-train device includes at least one first radio. The method also includes coupling at least one end-of-train device to the train. The end-of-train device includes at least one second radio. The method also includes communicating between the first and second radios using radio-ranging to determine a length of the train, and determining the integrity of the train based on the length of the train.

### BACKGROUND OF THE INVENTION

The present invention relates to railroad systems, and more particularly, to methods and systems for determining an integrity of a train.

At least some known trains are continually monitored during operation to ensure an integrity of the train. Specifically, the train is monitored to ensure that a separation has not occurred between any pairs of adjacent train cars. For example, in some known trains, the integrity of the train is verified by monitoring a brake pressure of the train. A rapid change in, or sudden loss of, brake pressure may be indicative of a split in the brake line. Accordingly, such split in the brake line may indicate that a separation of train cars has occurred. However, monitoring the brake pressure does not always provide a reliable indication of the train's integrity. Specifically, the brake pressure of the train may vary during train operation without a split having occurred in the brake line. Moreover, a split may occur in the brake line without a breach of the train's integrity.

In other known trains, the integrity of the train is monitored using GPS receivers that monitor the movement of both the head of the train and the end of the train. As is known, a difference in movement between the head of the train and the end of the train is often indicative of a separation within the train. However, GPS antennas may become blocked to satellite view causing inaccuracies in the GPS data. Further, the use of GPS receivers to determine train integrity requires two GPS receivers and, as such, the systems can be costly to install and/or maintain.

Moreover, in other known trains, the integrity of the train is determined by monitoring a length of the train. However, known methods of monitoring the length of the train require manual data entry by a driver in a cab of the train. Such manual data entry is subject to error and/or subject to not being entered timely. Accordingly, such methods are limited in determining the train integrity.

### BRIEF DESCRIPTION OF THE INVENTION

In one embodiment, a method for determining an integrity of a train is provided. The method includes coupling at least one head-of-train device to the train. The head-of-train device includes at least one first radio. The method also includes coupling at least one end-of-train device to the train. The end-of-train device includes at least one second radio. The method also includes communicating between the first and second radios using radio-ranging to determine a length of the train, and determining the integrity of the train based on the length of the train.

In another embodiment, a system for determining an integrity of a train is provided. The system includes at least one head-of-train device including at least one first radio, and at least one end-of-train device including at least one second radio. The radios are configured to communicate using radio-ranging to determine a length of the train. The integrity of the train is based on the length of the train.

In yet another embodiment, a train is provided. The train includes a head and an end. The train has a length measured from between the head and the end. The train also includes at least one head-of-train device coupled to the train at the head. The head-of-train device includes at least one first radio. The train also includes at least one end-of-train device coupled to the train at the end. The end-of-train device includes at least one second radio. The first and second radios are configured to communicate using radio-ranging to determine a length of the train. An integrity of the train is based on the length of the train.

### BRIEF DESCRIPTION OF THE DRAWINGS

FIG. 1 is a side view of an exemplary train;

FIG. 2 is a block diagram of an exemplary end-of-train device that may be used with the train shown in FIG. 1; and

FIG. 3 is a block diagram of an exemplary head-of-train device that may be used with the train shown in FIG. 1.

### DETAILED DESCRIPTION OF THE INVENTION

The present invention provides a system that may be used to determine and/or verify an integrity of a train. Specifically, the integrity of the train is an assessment that the cars of the train have not become disconnected. In the exemplary embodiment, the system includes a pair of radio transmitters that each include an antenna that extends above a height of the train. Accordingly, the radios can communicate with each other using radio-ranging to determine a length of the train. In the exemplary embodiment, the integrity of the train is based on the length of the train. As such, the present invention eliminates a need for manual data entry to determine the integrity of the train.

Further, in the exemplary embodiment, one of the radios is integrated with at least one of a brake pressure monitor and a device configured to determine movement of the train. Accordingly, in the exemplary embodiment, the integrity of the train is verified based on data received from either the brake pressure monitor and/or the device configured to determine movement of the train. In one embodiment, the device configured to determine movement of the train is at least one of a GPS receiver and an accelerometer. Moreover, in one embodiment at least one of the pair of radios is integrated with a processor that processes data associated with at least one of the head-of-train device and the end-of-train device. As will be appreciated by one of ordinary skill in the art, the present invention is not limited to use with trains, but rather, may also be used with other vehicles.

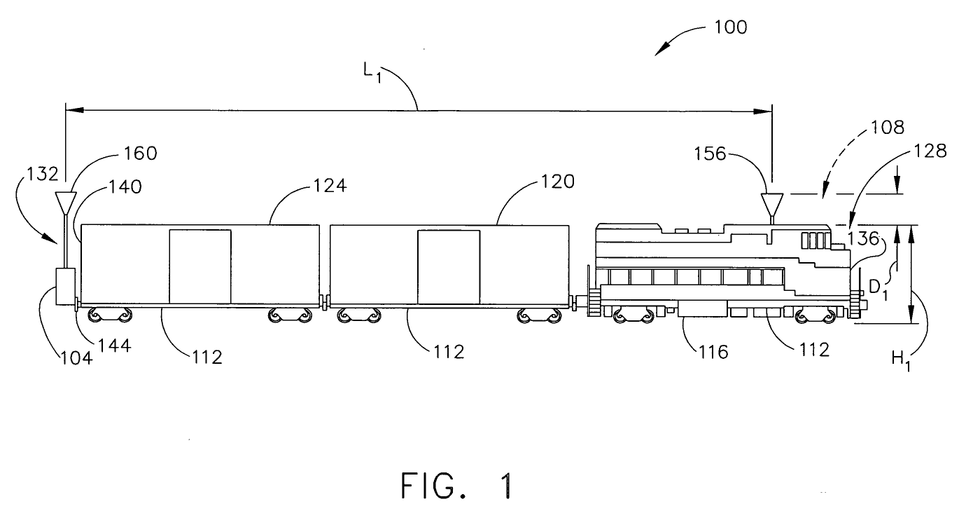

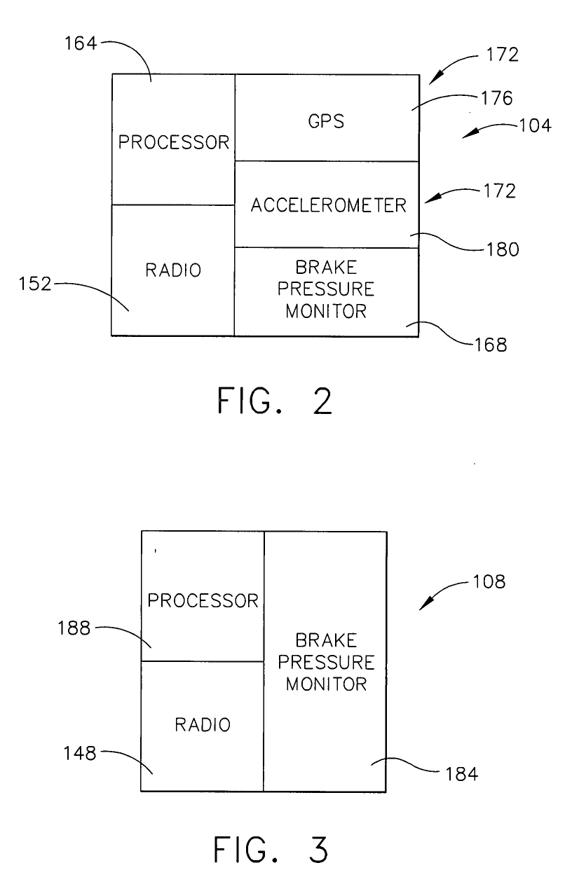

FIG. 1 is a view of an exemplary train 100. FIG. 2 is a block diagram of an exemplary end-of-train device 104 that may be used with train 100. FIG. 3 is a block diagram of an exemplary head-of-train device 108 that may be used with train 100. In the exemplary embodiment, train 100 includes only three cars 112. Specifically, in the exemplary embodiment, train 100 includes a first car 116, a second car 120, and a third car 124. As will be appreciated by one of ordinary skill in the art, train 100 may have any number of cars 112. Further, in the exemplary embodiment, train 100 includes a head 128 and an end 132. Specifically, head 128 is positioned at a forward end 136 of first car 116, and end 132 is positioned at an aft end 140 of third car 124.

In the exemplary embodiment, a head-of-train (HOT) device 108 is positioned at train head 128 and within first car 116. Further, in the exemplary embodiment, an end-of-train (EOT) device 104 is positioned at train end 132 and is attached to a coupling device 144 extending aftward from third car 124.

Further, in the exemplary embodiment, EOT device 104 includes a first radio 148, at least one of a processor 164, a brake pressure monitor 168, and/or at least one device 172 for determining movement of train 100. In one embodiment, device 172 for determining movement of train 100 is either a GPS receiver 176 and/or an accelerometer 180. In the illustrated embodiment, EOT device 104 includes all of processor 164, brake pressure monitor 168, GPS receiver 176, and accelerometer 180. Moreover, in the exemplary embodiment, HOT device 108 includes a second radio 152, at least one of a brake pressure monitor 184, and a processor 188.

In the exemplary embodiment, radios 148 and 152 each include an antenna 156 and 160 that extends a distance D₁ above a height H₁ of train 100. In the exemplary embodiment, height H₁ is defined and measured as the height of the tallest car 112 within train 100. Because of the height of antennas 156 and 160, radios 148 and 152 can use radio-ranging to communicate between EOT device 104 and HOT device 108 to determine a length L₁ of train 100 defined between train head 128 and train end 132. Specifically, a pulse transmitted by radio 148 is received by radio 152, such that a travel time of the pulse can be used to determine a distance between radios 148 and 152. As will be appreciated by one of ordinary skill in the art, the pulse could also be transmitted by radio 152 and received by radio 148. Further, because the determination is based on the speed of light, the determination, generally, has a precise accuracy. As such, radio-ranging is used to determine a precise length L₁ of train 100. Length L₁ is then used to determine an integrity of train 100. As such, in the exemplary embodiment, the determination of train integrity is made without a need for manual data entry by a driver of train 100.

Moreover, in the exemplary embodiment, brake pressure monitors 168 and 184, GPS receiver 176, and accelerometer 180 are used to verify the integrity of train 100. Specifically, in the exemplary embodiment, GPS receiver 176 and accelerometer 180 are utilized to determine movement of train 100. Specifically, GPS receiver 176 and/or accelerometer 180 is used to verify that train end 132 is moving at approximately the same time and/or rate as train head 128. Further, in the exemplary embodiment, GPS receiver 176 includes an antenna (not shown) that extends distance D₁ above height H₁. Accordingly, GPS receiver 176 has a greater capacity for communicating and receiving signals from a satellite (not shown). As such, a reliability of GPS data from GPS receiver 176 is facilitated to be increased.

In addition, in the exemplary embodiment, brake pressure monitors 168 and 184 are also used to verify the integrity of train 100. Specifically, a rapid change in and/or or loss of brake pressure, as measured by monitors 168 and 184, may be indicative of a split in a brake line (not shown) of train 100. Accordingly, such split in the brake line may indicate that a separation of train cars 112 has occurred. Accordingly, a measurement of the brake pressure is also used to verify the integrity of train 100.

Moreover, in the exemplary embodiment, processors 164 and 188 receive and process data associated with each of EOT device 104 and HOT device 108. Accordingly, EOT device 104 and HOT device 108 are utilized to determine length L₁ of train 100. Specifically, EOT device 104 and HOT device 108 use respective radios 148 and 152 to facilitate increasing an accuracy with which the length L₁ of train 100 is determined. Accordingly, the length L₁ of train 100 is utilized to determine an integrity of train 100. Moreover, EOT device 104 and HOT device 108 integrate brake pressure monitors 168 and 184, GPS receiver 176, and accelerometer 180 to verify the integrity of train 100. Accordingly, EOT device 104 and HOT device 108 facilitate increasing an accuracy of a determination of the integrity of train 100, while reducing costs associated with determining the integrity of train 100.

In one embodiment, a method for determining an integrity of a train is provided. The method includes coupling at least one head-of-train device to the train, wherein the head-of-train device includes at least one first radio. The method also includes coupling at least one end-of-train device to the train, wherein the end-of-train device includes at least one second radio. The method further includes communicating between the radios using radio-ranging to determine a length of the train, and determining the integrity of the train based on the length of the train. In the exemplary embodiment, radio-ranging is possible because the method includes extending an antenna of each radio a distance above a height of the train. Accordingly, in the exemplary embodiment, the method eliminates a need for manual data entry to determine the integrity of the train.

Further, in the exemplary embodiment, the method includes integrating at least one radio with at least one of a brake pressure monitor and a device configured to determine movement of the train. Accordingly, in the exemplary embodiment, the method also includes verifying the integrity of the train based on data from at least one of the brake pressure monitor and the device configured to determine movement of the train. In one embodiment, the device configured to determine movement of the train is at least one of a GPS receiver and an accelerometer. Moreover, in the exemplary embodiment, the method includes integrating at least one radio with a processor configured to process data associated with at least one of the head-of-train device and the end-of-train device.

As used herein, an element or step recited in the singular and proceeded with the word “a” or “an” should be understood as not excluding plural said elements or steps, unless such exclusion is explicitly recited. Furthermore, references to “one embodiment” of the present invention are not intended to be interpreted as excluding the existence of additional embodiments that also incorporate the recited features.

The above-described methods and systems facilitate accurate determinations of a length of a train. Accordingly, the length of the train is utilized to determine an integrity of the train. Moreover, the above-described methods and system integrate brake pressure monitors, a GPS receiver, and an accelerometer to verify the integrity of the train. Accordingly, the above-described systems and methods facilitate increasing an accuracy of a determination of the integrity of the train, while reducing costs associated with determining the integrity of the train.

Exemplary embodiments of systems and methods for determining an integrity of a train are described above in detail. The systems and methods illustrated are not limited to the specific embodiments described herein, but rather, components of the system may be utilized independently and separately from other components described herein. Further, steps described in the method may be utilized independently and separately from other steps described herein.

While the invention has been described in terms of various specific embodiments, those skilled in the art will recognize that the invention can be practiced with modification within the spirit and scope of the claims.

What is claimed is:

1. A method for determining an integrity of a train, said method comprising:
coupling at least one head-of-train device to the train, wherein the head-of-train device includes at least one first radio;
coupling at least one end-of-train device to the train, wherein the end-of-train device includes at least one second radio;
communicating between the first and second radios using radio-ranging to determine a length of the train; and
determining the integrity of the train based on the length of the train.

2. A method in accordance with claim 1 wherein each of the radios includes an antenna, said method further comprising coupling each radio to the train such that the antenna of each radio extends a distance above a height of the train.

3. A method in accordance with claim 1 further comprising integrating at least the second radio with at least one of a brake pressure monitor and a device configured to determine movement of the train.

4. A method in accordance with claim 3 wherein integrating at least the second radio with a device configured to determine movement of the train further comprises integrating at least the second radio with at least one of a GPS receiver and an accelerometer.

5. A method in accordance with claim 3 further comprising verifying the integrity of the train based on data received from at least one of the brake pressure monitor and the device configured to determine movement of the train.

6. A method in accordance with claim 1 further comprising integrating each radio with a processor configured to process data associated with at least one of the head-of-train device and the end-of-train device.

7. A method in accordance with claim 1 wherein said communicating between the first and second radios using radio-ranging to determine a length of the train facilitates determining the length of the train without manual data entry.

8. A system for determining an integrity of a train, said system comprising:
at least one head-of-train device comprising at least one first radio; and
at least one end-of-train device comprising at least one second radio, wherein said radios are configured to communicate using radio-ranging to determine a length of the train, wherein the integrity of the train is based on the length of the train.

9. A system in accordance with claim 8 wherein each of said radios comprises an antenna that extends a distance above a height of the train.

10. A system in accordance with claim 8 wherein at least said second radio is integrated with at least one of a brake pressure monitor and a device configured to determine movement of the train.

11. A system in accordance with claim 10 wherein said device configured to determine movement of the train is at least one of a GPS receiver and an accelerometer.

12. A system in accordance with claim 10 wherein data received from at least one of said brake pressure monitor and said device configured to determine movement of the train is used to verify the integrity of the train.

13. A system in accordance with claim 8 further comprising a processor coupled to each said radio, said processor configured to process data associated with at least one of said head-of-train device and said end-of-train device.

14. A system in accordance with claim 8 wherein said system facilitates determining the length of the train without manual data entry.

15. A train comprising:
a head and an end, said train having a length measured from between said head and said end;
at least one head-of-train device coupled to said train at said head, said head-of-train device comprising at least one first radio; and
at least one end-of-train device coupled to said train at said end, said end-of-train device comprising at least one second radio, said first and second radios are configured to communicate using radio-ranging to determine a length of said train, wherein an integrity of said train is based on the length of said train.

16. A train in accordance with claim 15 wherein each of said radios comprises an antenna that extends a distance above a height of said train.

17. A train in accordance with claim 15 wherein at least said second radio is integrated with at least one of a brake pressure monitor and a device configured to determine movement of said train.

18. A train in accordance with claim 17 wherein said device configured to determine movement of said train is at least one of a GPS receiver and an accelerometer.

19. A train in accordance with claim 17 wherein data received from at least one of said brake pressure monitor and said device configured to determine movement of said train is used to verify the integrity of said train.

20. A train in accordance with claim 15 further comprising a processor coupled to each said radio, said processor configured to process data associated with at least one of said head-of-train device and said end-of-train device.
